(19) United States
(12) Patent Application Publication
(10) Pub. No.: US 2012/0293980 A1
(43) Pub. Date: Nov. 22, 2012

(54) LIGHT-EMITTING UNIT, BACKLIGHT DEVICE AND DISPLAY APPARATUS

(75) Inventor: Takahiro Yoshikawa, Osaka-shi (JP)

(73) Assignee: SHARP KABUSHIKI KAISHA, Osaka-shi, Osaka (JP)

(21) Appl. No.: 13/574,890

(22) PCT Filed: Oct. 26, 2010
(86) PCT No.: PCT/JP2010/068907

§ 371 Date: Jul. 24, 2012

(30) Foreign Application Priority Data
Feb. 2, 2010 (JP) 2010-020886

(51) Int. Cl. F21V 9/16

(52) U.S. Cl. 362/84

(57) ABSTRACT

Provided is a light-emitting unit wherein the directivity of light to be emitted can be lowered while the increase of the number of members thereof is suppressed and the increase of the size thereof is suppressed. An LED package (light-emitting unit) (20) is provided with a base material (23) which includes an element mounting portion (21) and a sidewall portion (22), a light-emitting diode (24) which is disposed on the element mounting portion of the base material, and a sealing resin (25) which covers a light-emitting surface (24a) of the light-emitting diode and has light transmission properties. A recessed portion (26) is formed in a light emission surface (25a) of the sealing resin.

### TECHNICAL FIELD

The present invention relates to a light emitting unit, a backlight device, and a display apparatus, more particularly, to: a light emitting unit that includes a light emitting element and a seal member which covers a light emitting surface of the light emitting element; a backlight device and a display apparatus that include the light emitting unit.

### BACKGROUND ART

Conventionally, a backlight device of direct type using an LED (Light Emitting Diode) as a light source is known. In such a backlight device, to simplify the structure and achieve cost reduction, it is effective to reduce the number of LED packages (light emitting units).

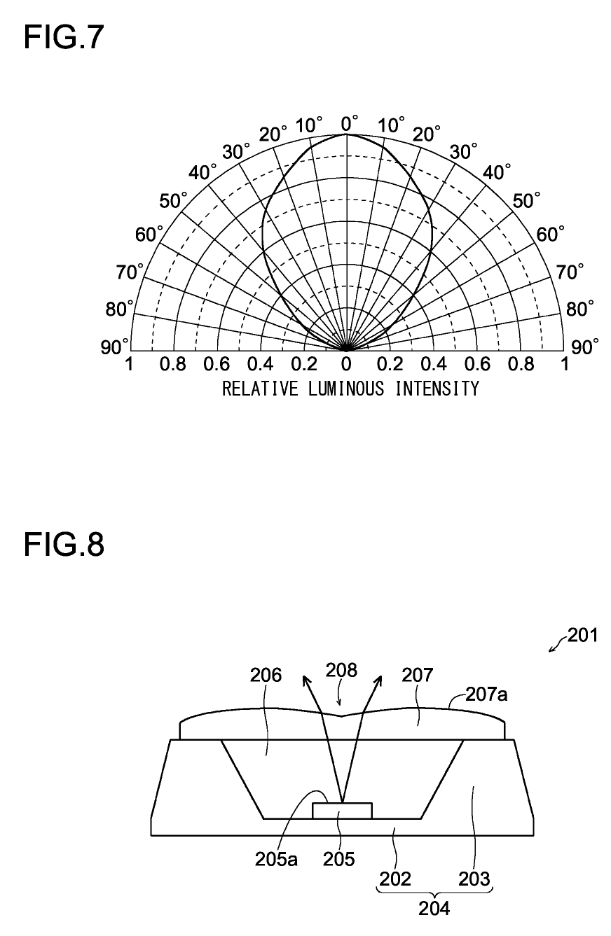

FIG. 6 is a sectional view showing a structure of an LED package as a conventional example. FIG. 7 is a directivity characteristic view of light emitted from the LED package as the conventional example shown in FIG. 6.

An LED package 101 as the conventional example, as shown in FIG. 6, is composed of: a base body 104 that includes an element mount portion 102 and a sidewall portion 103; a light emitting diode (a light emitting element) 105 that is disposed on the element mount portion 102 of the base body 104; and a seal resin (a seal member) 106 that covers a light emitting surface 105a of the light emitting diode 105. In this LED package 101, a light output surface (an upper surface) of the seal resin 106 is formed flat and is formed flush with an upper surface 103a of the sidewall portion 103.

Besides, the directivity of light output from the LED package 101 (the seal resin 106), as shown in FIG. 7, has a highest luminous intensity in a direction perpendicular to the light emitting surface 105a (the light output surface 106a of the seal resin 106) of the light emitting diode 105. Here, The angle (0° to 90°)in FIG. 7 indicates output angles of the light with respect to the direction perpendicular to the light emitting surface 105a (the light output surface 106a of the seal resin 106) of the light emitting diode 105.

In a backlight device that uses the LED package 101 as the conventional example, in a case where the number of the LED packages 101 is reduced, there is a disadvantage that brightness of a display panel other than a front portion (a portion right over) of the LED package 101 becomes low. In other words, there is a disadvantage that brightness unevenness occurs on the display panel. To improve this disadvantage, an LED package, which has a low directivity of output light, is proposed.

FIG. 8 is a sectional view showing a structure of a conventional LED package that has a low directivity of output light.

This LED package 201, as shown in FIG. 8, is composed of: a base body 204 that includes an element mount portion 202 and a sidewall portion 203; a light emitting diode (a light emitting element) 205 that is disposed on the element mount portion 202 of the base body 204; a seal resin (a seal member) 206 that covers a light emitting surface 205a of the light emitting diode 205; and a lens 207 that is disposed on the sidewall portion 203 of the base body 204 and the seal resin 206.

A concave portion 208 is formed at a central portion of a light output surface (an upper surface) of this lens 207. Because of this, light, which is emitted from the light emitting diode 205 and passes through the central portion of the lens 207, is refracted so as spread outward and is output from the lens 207. In other words, the directivity of the light output from the lens 207 (the LED package 201) becomes low (wide).

Here, to lower (widen) the directivity of the output light, an LED package in which members such as a lens and the like are disposed on the seal member, is disclosed on a patent document 1, for example.

### CITATION LIST

### Patent Literature

### PLT1: JP-A-2008-270144

### SUMMARY OF INVENTION

### Technical Problem

However, in the conventional LED package 201 shown in FIG. 8 and the LE package in the above patent document 1, it is necessary to dispose the members such as the lens and the like on the seal member. Because of this, in the case of reducing the number of the LED packages, the number of the LED packages is reducible, while there is a problem that the number of members which compose the LED package increases all the more because the members such as the lens and the like become necessary.

Besides, in the conventional LED package 201 shown in FIG. 8 and the LE package in the above patent document 1, it is necessary to dispose the members such as the lens and the like on the seal member; accordingly, there is a problem that the LED package becomes large and a device (e.g., a backlight device and the like) for housing the LED package also becomes large.

The present invention has been made to solve the above problems, and it is an object of the present invention to provide a light emitting unit, a backlight device and a display apparatus that are able to alleviate the number of members increasing, alleviate the size increase and lower the directivity of the output light.

### Solution to Problem

To achieve the above object, a light emitting unit according to a first aspect of the present invention includes: a base member that includes an element mount portion and a sidewall portion which encloses a circumference of the element mount portion; a light emitting element that is disposed on the element mount portion of the base member; and a seal member that covers a light emitting surface of the light emitting element and has a light transmission characteristic; wherein a concave portion is formed on a light output surface of the seal member.

In the light emitting unit according to the first aspect, as described above, by forming the concave portion on the light output surface of the seal member, it is possible to refract light, which is emitted from the light emitting element and passes through the seal member, so as to make the light spread outward and to output the light from the seal member. In other words, it is possible to lower (widen) directivity of the light output from the seal member (the light emitting unit). According to this, in a case where the light emitting unit is used, for example, in a display apparatus, even if the number of the light emitting units is reduced, it is possible to alleviate brightness unevenness occurring on a display panel. According to this, it is possible to simplify the structure of the display apparatus and reduce the cost.

Besides, it is possible to make the seal member function as a lens for lowering (widening) the directivity of the light output from the light emitting unit; accordingly, it is unnecessary to additionally dispose members such as a lens and the like on the seal member. According to this, it is possible to alleviate the number of members that compose the light emitting unit increasing and alleviate the light emitting unit becoming large.

Besides, in the light emitting unit according to the first aspect, as described above, by disposing on the base member the sidewall portion that encloses the circumference of the element mount portion, it is possible to alleviate the light leaking from a side of the light emitting unit. Besides, in a case where an inner surface of the sidewall portion functions as a reflection surface, it is possible to make the light, which is emitted from the light emitting element and travels to the side (the sidewall portion), reflect off the inner surface of the sidewall portion and to output the light from an upper surface (the light output surface) of the seal member. According to this, it is possible to improve light use efficiency.

In the light emitting unit according to the first aspect, preferably, a shortest distance from the element mount surface of the element mount portion to the light output surface of the seal member is smaller than a distance from the element mount surface of the element mount portion to an upper surface of the sidewall portion. According to this structure, it is possible to alleviate the seal member protruding upward beyond the upper surface of the sidewall portion (the base member); accordingly, it is possible to alleviate the light emitting unit becoming large.

In the light emitting unit according to the first aspect, the concave portion may be formed to have an inverted conical shape. According to this structure, it is possible to easily refract the light, which is emitted from the light emitting element and passes through the seal member, so as to make the light spread outward and to output the light from the seal member. In other words, it is possible to easily lower (widen) the directivity of the light output from the seal member (the light emitting unit). Besides, by forming the concave portion to have the inverted conical shape, it is possible to output the light evenly radially with respect an apex of the inverted conical shape.

In the light emitting unit according to the first aspect, a concave surface of the seal member, on which the concave portion is formed, may be formed to be a curved surface. According to this structure, it is possible to easily refract the light, which is emitted from the light emitting element and passes through the seal member, so as to make the light spread outward and to output the light from the seal member.

In the light emitting unit in which the concave surface of the seal member is formed to be the curved surface, the concave surface of the seal member may be formed to have a spherical surface shape. According to this structure, it is possible to output the light evenly radially with respect to a central portion of the concave surface.

In the light emitting unit according to the first aspect, preferably, the concave portion is formed by only one across a substantially entire region of the light output surface of the seal member. As described above, by forming the concave portion across the substantially entire region of the light output surface of the seal member, unlike a case where the concave portion is formed on, for example, a central portion only of the light output surface of the seal member, it is possible to easily refract light as well, which passes through a circumferential portion of the seal member, so as to make the light spread more outward and to output the light from the seal member. According to this, it is possible to more lower (widen) the directivity of the light output from the seal member (the light emitting unit).

In the light emitting unit according to the first aspect, preferably, a distance from the element mount surface of the element mount portion to the central portion of the light output surface of the seal member is smaller than a distance from the element mount surface of the element mount portion to a circumferential portion of the light output portion of the seal member. According to this structure, it is possible to form only the concave portion on the light output surface of the seal member without forming a convex portion.

In the light emitting unit according to the first aspect, preferably, luminous intensity of the light output from the seal member is highest in a direction inclined by 70±10° with respect to a direction perpendicular to the light emitting surface of the light emitting element. According to this structure, it is possible to sufficiently lower (widen) the directivity of the light output from the seal member (the light emitting unit). According to this, in a case where the light emitting unit is used, for example, in a display apparatus, it is possible to sufficiently alleviate brightness unevenness occurring on a display panel.

In the light emitting unit according to the first aspect, preferably, the inner surface of the sidewall portion is inclined with respect to the element mount surface of the element mount portion and functions as a reflection surface. According to this structure, it is possible to make the light, which is emitted from the light emitting element and travels to the side (the sidewall portion), reflect off the inner surface of the sidewall portion and to output the light from the upper surface (the light output surface) of the seal member. According to this, it is possible to improve the light use efficiency.

In the light emitting unit according to the first aspect, preferably, the seal member contains a fluorescent body. According to this structure, it is possible to convert at least part of the light emitted from the light emitting element into light that has a different color (wavelength). For example, in a case where the light emitting element is composed of a blue light emitting element and a fluorescent body for converting part of the blue light into yellow light is contained in the seal member, part of the blue light emitted from the blue light emitting element is converted into the yellow light. And, the yellow light and the blue light, which is not converted, are mixed with each other, whereby white light is obtained. As described above, by containing the fluorescent body into the seal member, it is possible to obtain the white light by means of only one light emitting element without using three light emitting elements (a blue light emitting element, a red light emitting element, and a green light emitting element) that emit blue light, red light and green light, respectively.

In the light emitting unit according to the first aspect, the light emitting element may be structured so as to include a blue light emitting diode.

A backlight device according to a second aspect of the present invention includes the light emitting unit having the above structure. According to this structure, it is possible to obtain a backlight device that is able to alleviate the number of members increasing, alleviate size increase and lower the directivity of the output light.

A display apparatus according to a third aspect of the present invention includes the backlight device having the above structure, and a display panel that is illuminated by the backlight device. According to this structure, it is possible to obtain a display apparatus that is able to alleviate the number of members increasing, alleviate the size increase and lower the directivity of the output light.

### Advantageous Effects of Invention

As described above, according to the present invention, it is possible to easily obtain a light emitting unit, a backlight device and a display apparatus that are able to alleviate the number of members increasing, alleviate the size increase and lower the directivity of the output light.

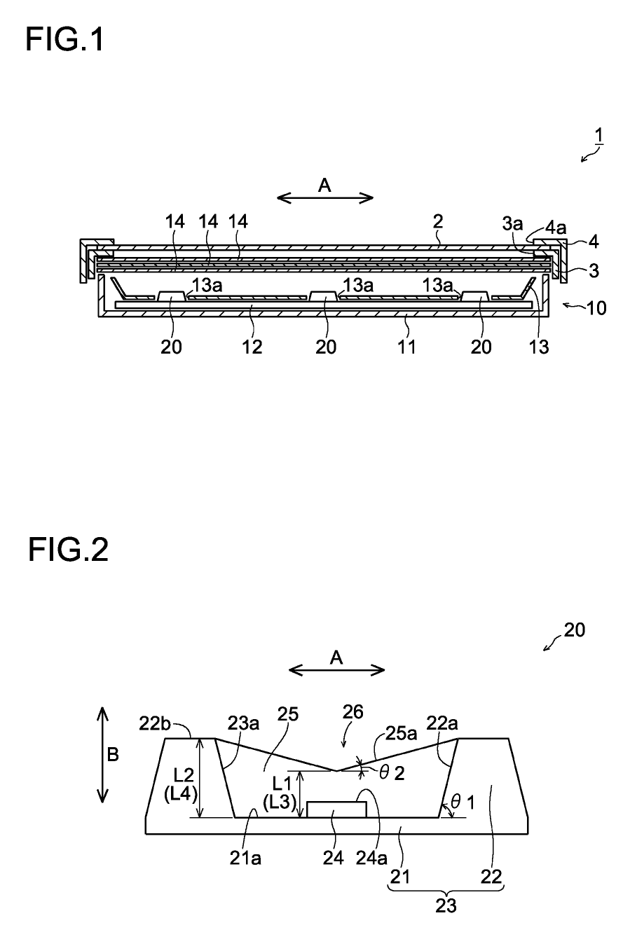

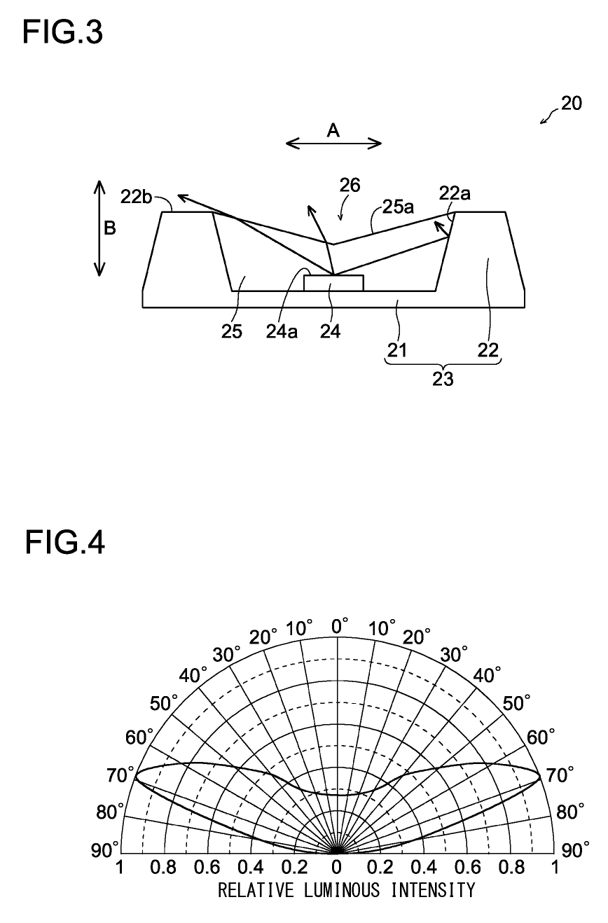

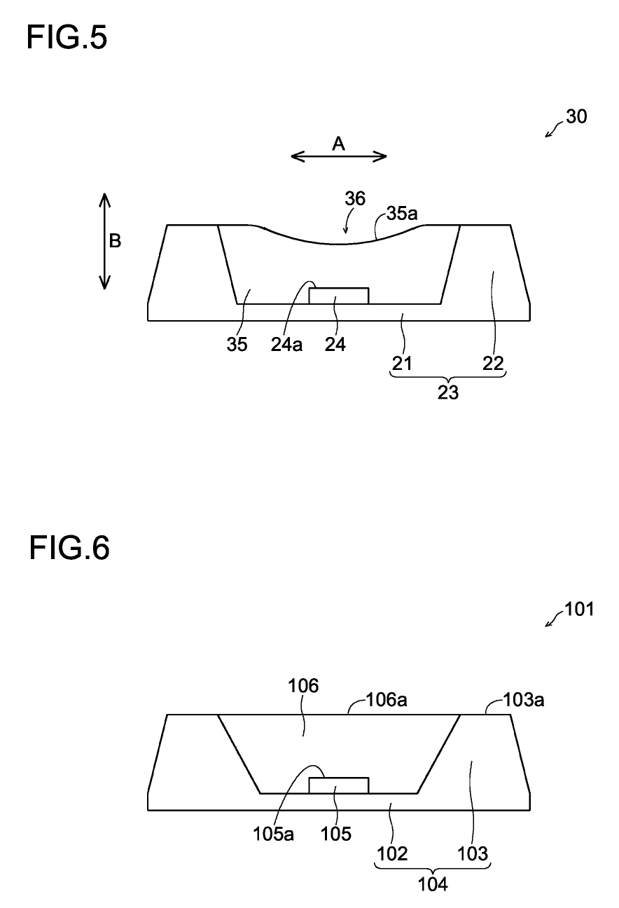

### BRIEF DESCRIPTION OF DRAWINGS

[FIG. 1] is a sectional view showing a structure of a liquid crystal display apparatus that includes an LED package according to an embodiment of the present invention.

[FIG. 2] is a sectional view showing a structure of an LED package according to an embodiment of the present invention.

[FIG. 3] is a sectional view for describing a structure of the LED package according to the embodiment of the present invention shown in FIG. 1.

[FIG. 4] is a directivity characteristic view of light output from the LED package according the embodiment of the present invention shown in FIG. 1.

[FIG. 5] is a sectional view showing a structure of an LED package according to a modification of the present invention.

[FIG. 6] is a sectional view showing a structure of an LED package according to a conventional example.

[FIG. 7] is a directivity characteristic view of light output from the LED package according the conventional example shown in FIG. 6.

[FIG. 8] is a sectional view showing a structure of a conventional LED package which has a lowered directivity of output light.

### DESCRIPTION OF EMBODIMENTS

Hereinafter, embodiments of the present invention are described with reference to the drawings.

With reference to FIG. 1 to FIG. 4, a liquid crystal display apparatus 1, which includes an LED package 20 according to an embodiment of the present invention, is described. Here, for the sake of easy understanding, there is a case where hatching is not applied to even a sectional view.

The liquid crystal display apparatus 1, which includes the LED package 20 according the embodiment of the present invention, composes a liquid crystal television receiver (not shown) and the like, for example. Besides, the liquid crystal display apparatus 1, as shown in FIG. 1, is composed of: a liquid crystal display panel 2; frames 3 and 4 that sandwich and hold the liquid crystal display panel 2; and a backlight device 10 of direct type that is disposed to oppose a rear side of the liquid crystal display panel 2. Here, the liquid crystal display apparatus 1 is an example of a “display apparatus” of the present invention, and the liquid crystal display panel 2 is an example of a “display panel” of the present invention. Besides, the LED package 20 is an example of a “light emitting unit” of the present invention.

The liquid crystal display panel 2 includes two glass boards that sandwich a not-shown liquid crystal layer. Besides, the liquid crystal display panel 2 is illuminated by the backlight device 10 to function as a display panel.

The frames 3 and 4 are provided with opening portions 3a and 4a through portions that correspond to a display region of the liquid crystal display panel 2.

The backlight device 10 is composed of: a backlight chassis 11; a wiring board 12 disposed on an upper surface of the backlight chassis 11; a reflection sheet 13 and a plurality of LED packages 20 disposed on the wiring board 12; and a plurality of optical sheets 14 disposed between the LED package 20 and the liquid crystal display panel 2.

The backlight chassis 11 is formed of a metal plate, for example. Besides, the backlight chassis 11 is formed to have a C-shaped sectional form, and houses the wiring board 12, the reflection sheet 13 and the plurality of LED packages 20.

The wiring board 12 is formed so as to extend in a predetermined direction (an A direction). Here, a plurality of the wiring board 12 are disposed in a direction (a direction perpendicular to the paper surface) which meets the A direction at right angles, though not shown.

The reflection sheet 13 is provided with an opening portion 13 through a portion that corresponds to a position where the LED package 20 is situated, and the LED package 20 protrudes upward (toward the liquid crystal display panel 2) via the opening portion 13a of the reflection sheet 13. Besides, the reflection sheet 13 has a function to reflect light upward (toward the liquid crystal display panel 2) that is emitted from the LED package 20 and reflected by the plurality of optical sheets 14.

The plurality of optical sheets 14 are composed of: a diffusion sheet that diffuses the light; a lens sheet that collects the light forward; and the like.

A plurality of the LED packages 20 are disposed on each of the wiring boards 12 along the direction (the A direction) in which the wiring board 12 extends. Besides, the LED package 20 is electrically connected to the wiring board 12.

Besides, the LED package 20, as shown in FIG. 2, is composed of: a base body 23 that includes an element mount portion 21 and a sidewall portion 22; a light emitting diode 24 disposed on the element mount portion 21 of the base body 23; and a seal resin 25 that covers a light emitting surface 24a of the light emitting diode 24. Here, the light emitting diode 24 is an example of a “light emitting element” of the present invention, and the seal resin 25 is an example of a “seal member” of the present invention.

The sidewall portion 22 of the base body 23 is formed so as to enclose a circumference of the element mount portion 21. Besides, an element mount surface (an upper surface) 21a of the element mount portion 21 and an inner surface 22a of the sidewall portion 22 of the base body 23 function as a reflection surface that has a function to reflect the light. Besides, the inner surface 22a of the sidewall portion 22 is formed so as to be inclined by a predetermined angle (θ1) with respect to a direction in which the element mount surface (the upper surface) 21a of the element mount portion 21 extends.

Besides, an element mount concave portion 23a, which is formed of the element mount portion 21 and the sidewall portion 22, is disposed on the base body 23. This element mount concave portion 23a is formed to have an inverted conical trapezoidal shape, for example.

The light emitting diode 24 is disposed at a central portion of the element mount surface (the upper surface) 21a of the element mount portion 21. Besides, the light emitting diode 24 is formed of a blue light emitting diode that emits blue light.

The seal resin 25 is composed of a resin layer having a light transmission characteristic and a fluorescent body (not shown) contained in the resin layer. This fluorescent body has a function to convert part of the blue light emitted from the light emitting diode 24 into yellow light. And, the yellow light and the blue light, which is not converted, are mixed with each other, whereby white light is output from the seal resin 25 (the LED package 20).

Here, in the present embodiment, on a light output surface (an upper surface) 25a of the seal resin 25, an inverted conical concave portion 26 is formed. This concave portion 26 is formed by only one across the entire region of the light output surface (the upper surface) 25a of the seal resin 25.

Specifically, the light output surface 25a of the seal resin 25 is formed so as to be inclined by a predetermined angle (θ2) with respect to the element mount surface 21a (the light emitting surface 24a of the light emitting diode 24) of the element mount portion 21.

Besides, a shortest distance L1 from the element mount surface (the upper surface) 21a of the element mount portion 21 to the light output surface 25a of the seal resin 25 is smaller than a distance L2 from the element mount surface 21a of the element mount portion 21 to an upper surface 22b of the sidewall portion 22.

Besides, a distance L3 (=L1) from the element mount surface (the upper surface) 21a of the element mount portion 21 to a central portion (an apex of the inverted conical shape of the concave portion 26) of the light output surface 25a of the seal resin 25 is smaller than a distance L4 from the element mount surface 21a of the element mount portion 21 to a circumferential portion of the light output surface 25a of the seal resin 25.

Besides, the distance L4 from the element mount surface 21a of the element mount portion 21 to the circumferential portion of the light output surface 25a of the seal resin 25 is substantially equal to the distance L2 from the element mount surface 21a of the element mount portion 21 to the upper surface 22b of the sidewall portion 22. In other words, the seal resin 25 is formed so as not to protrude beyond the upper surface 22b of the sidewall portion 22.

Besides, the seal resin 25 is formed such that the apex of the inverted conical shape of the concave portion 26 is situated right over the light emitting diode 24.

As described above, the concave portion 26 is formed on the light output surface 25a of the seal resin 25; accordingly, as shown in FIG. 3, the light passing through the seal resin 25 is refracted so as to spread outward and to be output from the light output surface 25a of the seal resin 25. In the first embodiment, the concave portion 26 is formed across the entire region of the light output surface 25a of the seal resin 25; accordingly, not only the light passing through the central portion of the light output surface 25a but also the light passing through the circumferential portion is refracted so as to spread more outward and to be output from the light output surface 25a. As described above, the seal resin 25 functions as a lens for lowering (widening) the directivity of the light output from the LED package 20.

Besides, as shown in FIG. 4, luminous intensity of the light output from the seal resin 25 (the LED package 20) is highest in a direction that is inclined by about 70±10° with respect to a direction (a B direction) perpendicular to the light emitting surface 24a (the element mount surface 21a of the element mount portion 21) of the light emitting diode 24. Besides, the luminous intensity of the light output from the seal resin 25 is lowest at 0° in a range of 0° to about 80° with respect to the direction (the B direction) perpendicular to the light emitting surface 24a of the light emitting diode 24. Here, the angle (0° to 90°) in FIG. 4. indicates light output angles with respect to the direction (the B direction) perpendicular to the light emitting surface 24a of the light emitting diode 24.

In the present embodiment, as described above, by forming the concave portion 26 on the light output surface 25a of the seal resin 25, it is possible to refract the light, which is emitted from the light emitting diode 24 and passes through the seal resin 25, so as to make the light spread outward and to output the light from the seal resin 25. In other words, it is possible to lower (widen) the directivity of the light output from the seal resin 25 (the LED package 20). According to this, even if the number of the LED packages 20 is reduced compared with the conventional liquid crystal display apparatus, it is possible to alleviate brightness unevenness occurring on the liquid crystal display panel 2. According to this, it is possible to simplify the structure of the liquid crystal display apparatus 1 and reduce the cost.

Besides, making the seal resin 25 function as the lens for lowering (widening) the directivity of the light output from the LED package 20, it is unnecessary to additionally dispose, on the seal rein 25, members such as a lens and the like for lowering (widening) the directivity of the light output from the LED package 20. According to this, it is possible to alleviate the number of members that compose the LED package 20 increasing and alleviate the LED package 20 becoming large.

Besides, in the present embodiment, as described above, by forming, on the base member 23, the sidewall portion 22 for enclosing the circumference of the element mount portion 21, it is possible to alleviate the light leaking from a side of the LED package 20.

Besides, in the present embodiment, as described above, by making the shortest distance L1 from the element mount surface 21a to the light output surface 25a of the seal resin 25 smaller than the distance L2 from the element mount surface 21a to the upper surface 22b of the sidewall portion 22, it is possible to alleviate the seal resin 25 protruding upward beyond the upper surface 22b of the sidewall portion 22 (the base member 23); accordingly, it is possible to more alleviate the LED package 20 becoming large.

Besides, in the present embodiment, as described above, by forming the concave portion 26 to have the inverted conical shape, it is possible to easily refract the light, which is emitted from the light emitting diode 24 and passes through the seal resin 25, so as to make the light spread outward and to output the light from the seal resin 25. In other words, it is possible to easily lower (widen) the directivity of the light output from the seal resin 25 (the LED package 20). Besides, by forming the concave portion 26 to have the inverted conical shape, it is possible to output the light evenly radially with respect the apex of the inverted conical shape.

Besides, in the present embodiment, as described above, by forming the concave portion 26 across the entire region of the light output surface 25a of the seal resin 25, unlike a case where the concave portion 26 is formed at only the central portion of the light output surface 25a of the seal resin 25, it is possible to refract the light as well, which passes through the circumferential portion of the seal resin 25, so as to make the light spread more outward and to output the light from the seal resin 25. According to this, it is possible to more lower (widen) the directivity of the light output from the seal resin 25 (the LED package 20).

Besides, in the present embodiment, as described above, by making the distance L3 (=L1) from the element mount surface 21a to the light output surface 25a of the seal resin 25 smaller than the distance L4 (=L2) from the element mount surface 21a to the circumferential portion of the light output surface 25a of the seal resin 25, it is possible to form only the concave portion 26 on the light output surface 25a of the seal resin 25 without forming a convex portion.

Besides, in the present embodiment, as described above, by composing the seal resin 25 such that the luminous intensity become highest in the direction that is inclined by about 70±10° with respect to the direction (the B direction) perpendicular to the light emitting surface 24a of the light emitting diode 24, it is possible to sufficiently lower (widen) the directivity of the light output from the seal resin 25 (the LED package 20). According to this, it is possible to sufficiently alleviate brightness unevenness occurring on the liquid crystal display panel 2.

Besides, in the present embodiment, as described above, by inclining the inner surface 22a of the sidewall portion 22 with respect to the element mount surface 21a of the element mount portion 21 and making the inner surface 22a function as the reflection surface, it is possible to reflect the light, which is emitted from the light emitting diode 24 and travels to the side (the sidewall portion 22), by means of the inner surface 22a of the sidewall portion 22 and to output the light from the light output surface (the upper surface) 25a of the seal resin 25. According to this, it is possible to improve light use efficiency.

Here, it should be considered that the embodiments disclosed this time are examples in all respects and are not limiting. The scope of the present invention is not indicated by the above description of the embodiments but by the claims, and all modifications within the scope of the claims and the meaning equivalent to the claims are covered.

For example, in the above embodiments, the example is described, in which the display apparatus is applied to a liquid crystal display apparatus; however, the present invention is not limited to this, and the display apparatus is applicable to a display apparatus other than the liquid crystal display apparatus.

Besides, in the above embodiments, the example is described, in which a light emitting diode is used as the light emitting element; however, the present invention is not limited to this, and a light emitting element other than the light emitting diode may be used.

Besides, in the above embodiments, the example is described, in which the light emitting diode is formed of a blue light emitting diode; however, the present invention is not limited to this, and the light emitting diode may be formed of a light emitting diode other than the blue light emitting diode. In this case, for example, a blue-purple light emitting diode, which emits blue-purple light, may be used, and three kinds of fluorescent bodies, which convert the blue-purple light into red light, blue light, and green light, respectively may be used. According to this structure as well, it is possible to obtain the white light by using only one light emitting diode without using, for example, three light emitting diodes (a blue light emitting diode, a red light emitting diode and a green light emitting diode) which emit the blue light, the red light and the green light, respectively.

Besides, in the above embodiment, the example is described, in which the concave portion is formed so as to have an inverted conical shape; however, the present invention is not limited to this, and the concave portion may be formed to have an inverted quadrangular pyramid (an inverted polyhedral pyramid) shape. Besides, for example, as in an LED package 30 shown in FIG. 5 according to a modification of the present invention, a concave portion 36 may be formed. Specifically, a concave surface 35a of a seal resin 35, on which the concave surface 36 is formed, may be formed to have a curved shape when seeing a sectional view. In other words, the concave surface 35a may be formed to have a curved surface. Besides, the concave surface 35a, as shown in FIG. 5, may be formed to have a spherical surface shape. Here, even in the case where the concave surface 35a is formed to have the curved shape when seeing a sectional view, only a central portion of the concave portion 35a may be formed to have a downward sharpened shape.

Besides, in the above embodiments, the example is described, in which a seal resin is used as the seal member; however, the present invention is not limited to this, and a seal member formed of a material other than the resin may be used.

### REFERENCE SIGNS LIST

1 liquid crystal display apparatus (display apparatus)
2 liquid crystal display panel (display panel)
10 backlight device
20, 30 LED packages (light emitting units)
21 element mount portion
21a element mount surface
22 sidewall portion
22a inner surface
23 base member
24 light emitting diode (light emitting element)
24a light emitting surface
25, 35 seal resins (seal members)
25a light output surface
26, 36 concave portions
35a concave surface
L1 shortest distance
L2, L3, L4 distances

1. A light emitting unit comprising:
a base member that includes an element mount portion and a sidewall portion which encloses a circumference of the element mount portion;
a light emitting element that is disposed on the element mount portion of the base member; and
a seal member that covers a light emitting surface of the light emitting element and has a light transmission characteristic; wherein
a concave portion is formed on a light output surface of the seal member.

2. The light emitting unit according to claim 1, wherein
a shortest distance from an element mount surface of the element mount portion to the light output surface of the seal member is smaller than a distance from the element mount surface of the element mount portion to an upper surface of the sidewall portion.

3. The light emitting unit according to claim 1, wherein
the concave portion is formed to have an inverted conical shape.

4. The light emitting unit according to claim 1, wherein
a concave surface of the seal member, on which the concave portion is formed, is formed to be a curved surface.

5. The light emitting unit according to claim 4, wherein
the concave surface of the seal member is formed to have a spherical surface shape.

6. The light emitting unit according to claim 1, wherein
the concave portion is formed by only one across a substantially entire region of the light output surface of the seal member.

7. The light emitting unit according to claim 1, wherein
a distance from the element mount surface of the element mount portion to a central portion of the light output surface of the seal member is smaller than a distance from the element mount surface of the element mount portion to a circumferential portion of the light output portion of the seal member.

8. The light emitting unit according to claim 1, wherein
luminous intensity of light output from the seal member is highest in a direction inclined by 70±10° with respect to a direction perpendicular to the light emitting surface of the light emitting element.

9. The light emitting unit according to claim 1, wherein
an inner surface of the sidewall portion is inclined with respect to the element mount surface of the element mount portion and functions as a reflection surface.

10. The light emitting unit according to claim 1, wherein
the seal member contains a fluorescent body.

11. The light emitting unit according to claim 1, wherein
the light emitting element includes a blue light emitting diode.

12. A backlight device comprising the light emitting unit according to claim 1.

13. A display apparatus comprising:
the backlight device according to claim 12; and
a display panel that is illuminated by the backlight device.
